(19) United States
(12) Patent Application Publication
(10) Pub. No.: US 2016/0132920 A1
(43) Pub. Date: May 12, 2016

(54) METHOD AND SYSTEM FOR IMPLEMENTING AN AWARD DISTRIBUTION, EXCHANGE AND REDEMPTION PROGRAM

(71) Applicant: Richard Postrel, Miami Beach, FL (US)

(72) Inventor: Richard Postrel, Miami Beach, FL (US)

(21) Appl. No.: 14/954,071

(22) Filed: Nov. 30, 2015

Related U.S. Application Data
(63) Continuation of application No. 13/690,735, filed on Nov. 30, 2012, now abandoned.

(51) Int. Cl. G06Q 30/02; G06Q 30/06; G06Q 50/00

(52) U.S. Cl. CPC G06Q 30/0233; G06Q 50/01; G06Q 30/0601

(57) ABSTRACT

A method and system for providing a multi-user, multi-celebrity award distribution, exchange and redemption program by allocating in an award server computer a plurality of sets of celebrity awards, each of the plurality of sets of celebrity awards associated with one of a plurality of celebrities; monitoring web activities of a plurality of users interacting over a computer network; and for each of the plurality of celebrities and for each of the plurality of users, determining a celebrity sub-score based on a correlation between the celebrity and the monitored web activities of the user, and distributing, based on the celebrity sub-score for the celebrity with the user, a portion of the set of celebrity awards associated with the celebrity to a user account associated with the user.

### TECHNICAL FIELD

This invention relates to an award distribution, exchange and redemption program, and in particular to a system and method for providing a platform that enables users to earn awards from celebrities that they mention, follow or otherwise engage with, to trade those awards amongst each other, and to redeem awards for goods and service associated with the celebrities or with groups of associated celebrities forming a celebrity cluster.

### BACKGROUND OF THE INVENTION

Services exist that purport to measure the popularity and/or marketability of celebrities such as actors, athletes, musicians, entertainers, and the like. For example, the Q Score or quotient factor is a measurement of the familiarity and appeal of a brand, company, celebrity, or television show. The higher the Q Score, the more highly regarded the item or person is among the group that is familiar with them. Q Scores and other variants are primarily used by the media, marketing, advertising and public relations industries. Q Scores are determined by conducting surveys that inquire as to how much the respondent likes the person or item being surveyed.

Reward programs are in a different field of endeavor, and generally function such that issuers provide a reward or incentive for a person to purchase goods and services from the issuer or use certain the issuer's financial instruments such as credit cards. Issuers such as airlines host frequent flyer programs, for example, which will provide miles into a user account based upon a flight taken with the airline. Issuers such as credit card companies like AMERICAN EXPRESS will provide reward points (MEMBERSHIP REWARDS) into a user account for each dollar spent using the AMERICAN EXPRESS card. Issuers that are hotel chains such a Marriott will provide their customers with reward points into a user account for each night spent in a Marriott brand hotel. Once the user has amassed a certain number or reward points into his account with a given issuer, he is able to redeem them with that issuer for an item of value, such as a seat upgrade on a flight or a free hotel room, etc.

It is desired to be able to measure the popularity and marketability of a celebrity, which is defined further herein, in a more effective and precise manner than what is currently available. Rather than simply taking a survey, it is desired to observe certain actions of members of the public in order to assess the celebrity's popularity in the eye of the public. The present invention uses an award system similar to reward programs in a manner previously unavailable that benefits the industries that desire such celebrity popularity metrics (i.e. sponsors, advertisers etc.) in addition to the members of the public that participate in such system.

### SUMMARY OF THE INVENTION

Therefore, provided is a system and method for providing a celebrity award distribution, exchange and redemption program. A celebrity, as used herein, refers to any entity, whether natural or legal, that has some degree of fame or notoriety in any aspect, and/or is in the public eye to any degree, including but not limited to entertainers, actors, actresses, musicians, songwriters, composers, comedians, athletes, announcers, commentators, authors, businesses, brands, executives, politicians, judges, justices, attorneys, criminals, fictitious characters, licensed properties, television shows, movies, doctors, software developers, philanthropists, and the like. The present invention provides a system and method to observe, measure, analyze, and undertake actions towards revising and otherwise managing the popularity and perception of any such celebrity in the eyes and minds of the relevant public. This enables any interested party, such as the celebrity themselves, their agents, sponsors, advertisers and the like, to assess the popularity of the celebrity and thus quantify the value of that celebrity in certain endeavors such as advertising and sponsorship. The present invention provides a means for quantifying numerous criteria and involving members of the public in this methodology by distributing awards to those members of the public based on various events that take place with respect to the celebrity, and also to evaluate the performance of that celebrity based on the awards that have been distributed on their behalf. This enables a celebrity to be rated in a more meaningful way than is heretofore available. Thus, by involving users (member of the public), the present invention implements metrics most relevant to gauging the popularity of a given celebrity. By distributing celebrity awards to users based on activities that may be measured (such as web activities), and then monitoring the distribution of those celebrity awards across various channels, the present invention is able to provide insight and intelligence to rating those celebrities for sponsorship, advertising, and various other purposes.

The term awards as used herein refers to any unit of measure that functions within the confines of this invention, and may also be referred to as rewards, reward points, credits, values, etc. The celebrity awards function in a manner similar to known reward point system, in that the celebrity awards may be quantified in units and may be earned as a result of some defined act, stored in an account associated with the user that has earned the awards, traded, aggregated, clustered, purchased, sold, optioned, and redeemed, all of which will be described in further detail herein.

The method implemented in the present invention for providing a celebrity award distribution, exchange and redemption program operates on a system that includes a web monitoring service interconnected with a computer network such as the Internet, and is configured to monitor web activities of numerous users interacting over the web with a user computing device. The system also has an award server computer with a database(s) for storing various sets of celebrity awards, each of which is allocated to and associated with a particular celebrity. The award server computer also has processing means programmed to perform the functions of the celebrity award distribution, exchange and redemption program as described herein.

The present invention operates generally as follows. A set of celebrity awards associated with a particular celebrity is allocated in the awards database of the award server computer.

Various web activities of users interacting over the web with their user computing device are monitored by the web monitoring service. A celebrity sub-score, based on a correlation between the monitored web activities of a particular user and the celebrity, is then determined. Based on the celebrity sub-score, a portion of the previously-allocated celebrity awards are distributed to an award account associated with the user. The system of this invention therefore includes a web monitoring server computer interconnected with a computer network including processing means for monitoring web activities of a user interacting over the web with a user computing device. The system also has an award server computer with a database for storing a set of celebrity awards allocated to and associated with a given celebrity. The award server computer also has processing means programmed determine a celebrity sub-score based on a correlation between the monitored web activities of the user and the celebrity, and then distribute, based on the celebrity sub-score, a portion of the celebrity awards to a user award account associated with the user, which may then be stored in the in the awards database of the award server computer.

The celebrity sub-score may be determined as a function of the user mentioning the celebrity, and/or the user following the celebrity. For example, the celebrity sub-score may be determined as a function of the user mentioning the celebrity in an internet short messaging service message (such as TWITTER), in a social networking post (such as FACEBOOK), in a photograph post (such as INSTAGRAM), in a text message, in a blog post, in a web page, and/or in an email message, and the like. In these cases, the celebrity sub-score may be determined as a function of the frequency of the user mentioning the celebrity, of the total number of times the user mentions the celebrity, of the user mentioning the celebrity in a positive manner, and/or of the user mentioning the celebrity in a negative manner, etc. In those cases in which the celebrity sub-score is determined as a function of the user following the celebrity, this may occur by following the celebrity on an internet short messaging service message, on a social networking service, on a photograph posting service, and the like. Similarly, the celebrity sub-score may be determined as a function of another member of a social network to which the user belongs mentioning and/or following the celebrity.

In a further embodiment, a celebrity super-score may be determined as a function of collating sub-scores of a number of users. Also, the celebrity super-score may be determined as a function of mentions of the celebrity on broadcast media, which may be television programming, radio programming, and the like. Optionally, the celebrity super-score may be determined as a function of the content of the mentions of the celebrity on the broadcast media, the quantity of the mentions of the celebrity on the broadcast media, the recency of the mentions of the celebrity on the broadcast media, the velocity of the mentions of the celebrity on the broadcast media, and/or the rapidity of the mentions of the celebrity on the broadcast media.

Further optionally, a sponsoring entity may provide a sponsorship to a celebrity based on the super-score of the celebrity. In this event, the set of celebrity awards associated with the celebrity may be allocated based on the sponsorship of the celebrity.

In addition, a web page may be provided that displays the celebrity super-score and other data with respect to the monitored web activities. The web page may also provide a comparison of the celebrity super-score with other celebrity super-scores. This provides any celebrity or other interested party (such as an agent of the celebrity, a sponsor of the celebrity, etc.) with a means for understanding the popularity of the celebrity as measured by the system of the present invention, individually and/or in comparison with other celebrities, in order to gauge the value or worth of that celebrity to that sponsor.

In an additional embodiment that provides an award exchange, purchase and bidding system, the award server computer receives from a first user an offer to trade a first group of celebrity awards associated with a first celebrity from the first user's account in exchange for a second group of celebrity awards associated with a second celebrity. The award server computer sends this offer to other users in the system, and then receives from a second user an acceptance of the offer to trade with the first user, by offering to the first user the second group of celebrity awards from the second user's account. The award server computer may then execute the trade between the first user and the second user by subtracting from the first user's account the first group of celebrity awards and adding them to the second user's account, and subtracting from the second user's account the second group of celebrity awards and adding them to the first user's account.

The award server computer may also receive from a first user a request to purchase a first group of celebrity awards associated with a first celebrity. The award server computer sends the request to other users in the system, and then receives from a second user an agreement to sell to the first user the first group of celebrity awards. The award server computer the executes the purchase by subtracting from the second user's account the first group of celebrity awards and adding them to the first user's account. Similarly, the award server computer may also receive from a first user a request to purchase a first group of celebrity awards associated with a first celebrity, and the award server computer executes the purchase by subtracting from a set of celebrity awards associated with the first celebrity allocated in the award server computer the first group of celebrity awards and adding them to the first user's account. Consideration may be paid as may be agreed to in exchange for any of these services.

Alternatively, the award server computer may receive from a first user a request to purchase an option to purchase in the future a first group of celebrity awards associated with a first celebrity. Then, the award server computer may execute the option purchase by establishing an option purchase price and conveying to the first user the option to purchase in the future the first group of celebrity awards in exchange for consideration equivalent to the option purchase price.

In an award redemption phase of the invention, the award server computer may receive from a first user a request to redeem a first group of celebrity awards associated with a first celebrity from the first user's account by subtracting from the first user's account the first group of celebrity awards in exchange for an item associated with the first celebrity. Alternatively, the award server computer may form a celebrity cluster comprising at least a first celebrity and a second celebrity. The award server computer would then receive from a first user a request to redeem from the first user's account a first group of celebrity awards associated with the first celebrity and a second group of celebrity awards associated with the second celebrity in exchange for an item associated with the celebrity cluster.

### BRIEF DESCRIPTION OF THE DRAWING

FIG. 1 is a block diagram of the components of this invention.

FIG. 2 is a basic flowchart of the method of the present invention.

FIG. 3 is an illustration of raw data tables generated in accordance with this invention.

FIG. 4 is an illustration of collated data tables and awards accounts generated in accordance with this invention.

FIG. 5 is a more detailed flowchart of the method of the present invention.

FIG. 6 is an illustration of the web page generation process of the present invention.

FIG. 7 is a screen shot of a first web page used as a celebrity awards dashboard in this invention.

FIG. 8 is a screen shot of a second web page used as a celebrity awards dashboard in this invention.

FIG. 9 is an illustration of the process in which two users exchange celebrity awards with each other.

FIG. 10 is an illustration of the process in which a user purchases celebrity awards from another user.

FIG. 11 is an illustration of the process in which a user purchases celebrity awards from the award server computer.

FIG. 12 is an illustration of the process in which a user purchases an option to purchase in the future celebrity awards from the award server computer.

FIG. 13 is a screen shot of a first web page of a user award account dashboard used in this invention.

FIG. 14 is a screen shot of a second web page of a user award account dashboard used in this invention.

### DESCRIPTION OF THE PREFERRED EMBODIMENTS

The preferred embodiment of the present invention will now be described. The present invention provides a celebrity awards platform that enables interested parties to analyze the metrics produced by the system that reflect the popularity of a celebrity as measured across numerous channels. As stated above, a celebrity, as used herein, refers to any entity, whether natural or legal, that has some degree of fame or notoriety in any aspect, and/or is in the public eye to any degree, including but not limited to entertainers, actors, actresses, musicians, songwriters, composers, comedians, athletes, announcers, commentators, authors, businesses, brands, executives, politicians, judges, justices, attorneys, criminals, fictitious characters, licensed properties, television shows, movies, doctors, software developers, philanthropists, and the like.

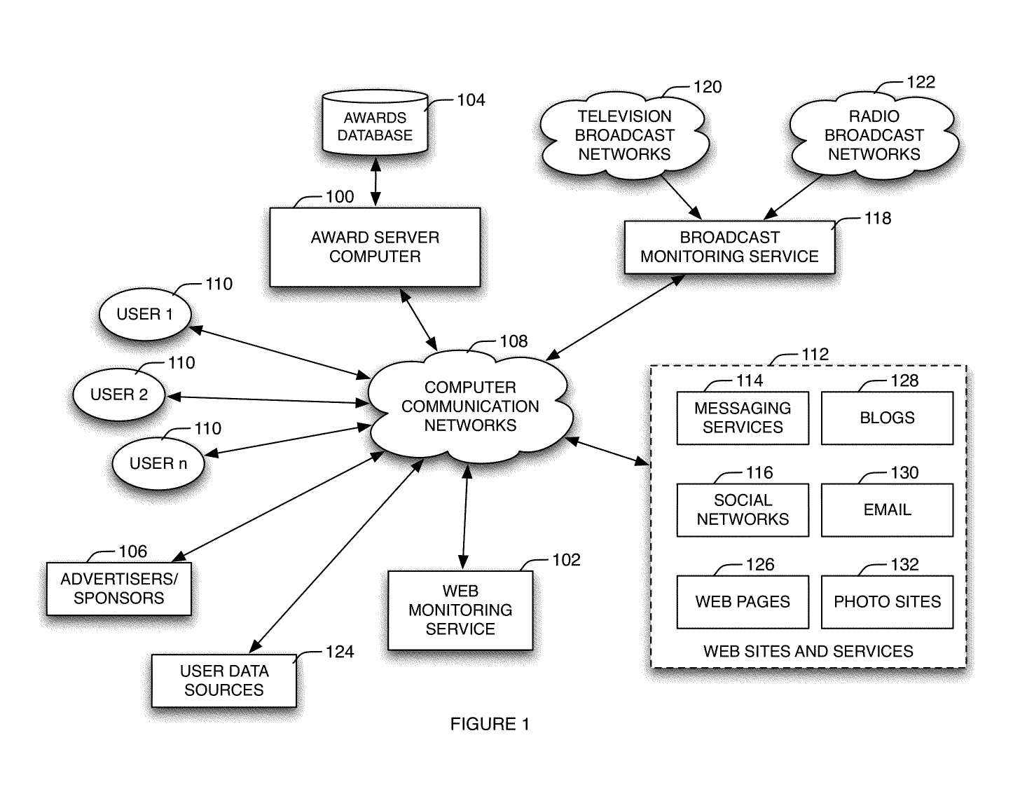

FIG. 1 provides a basic block diagram of the system of the present invention. As shown in FIG. 1, this system includes an award server computer 100, an associated awards database 104, a web monitoring service 102 (shown as an independent entity; however, its functionality may be incorporated into the award server computer 100), and advertisers and sponsors 106. Also shown are a plurality of users 110, each of whom operate a user computing device (not shown) such as a computer, smartphone, tablet or the like. Various web sites and services 112 include but are not limited to an internet short messaging service 114 (such as TWITTER), a social networking service 116 (such as FACEBOOK or LINKEDIN), web pages 126, blogs 128, email host sites 130, and photograph posting sites (such as INSTAGRAM or FLICKR), but may include many other types of web services as will be described further herein. These various entities are shown communicating as well known in the art over a communication network(s) 108, for example the Internet, and wireless networks in communication with the Internet. A broadcast monitoring service 118 is shown interfacing with the award server computer 100. The broadcast monitoring service also interfaces with various television broadcast networks 120 and radio broadcast networks 122 as shown. Third party user data sources 124, such as EXPERIAN, are accessible by the award server computer for celebrity popularity analysis. All of these components of the system will be described in further detail herein.

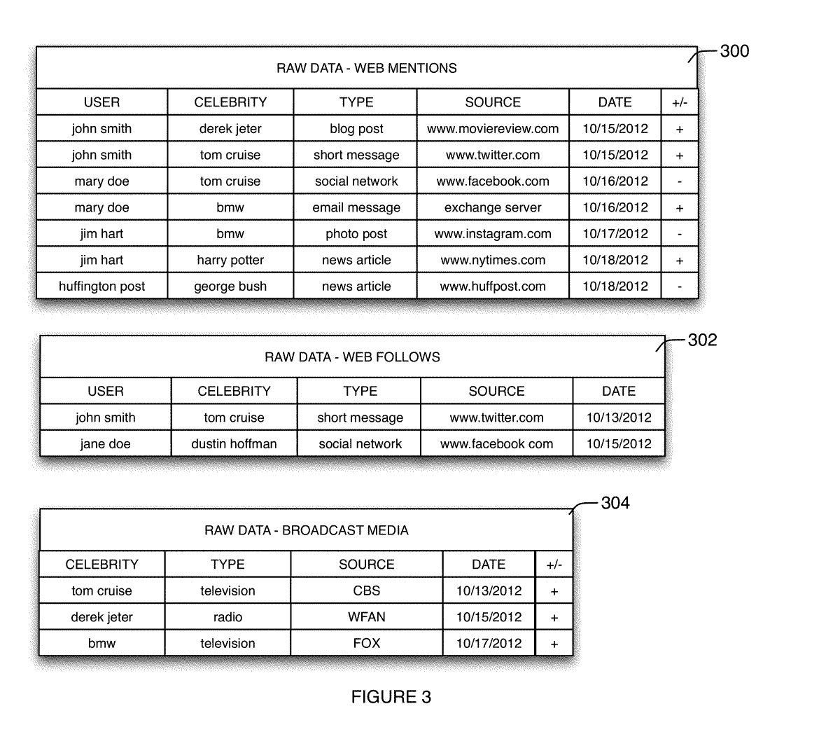

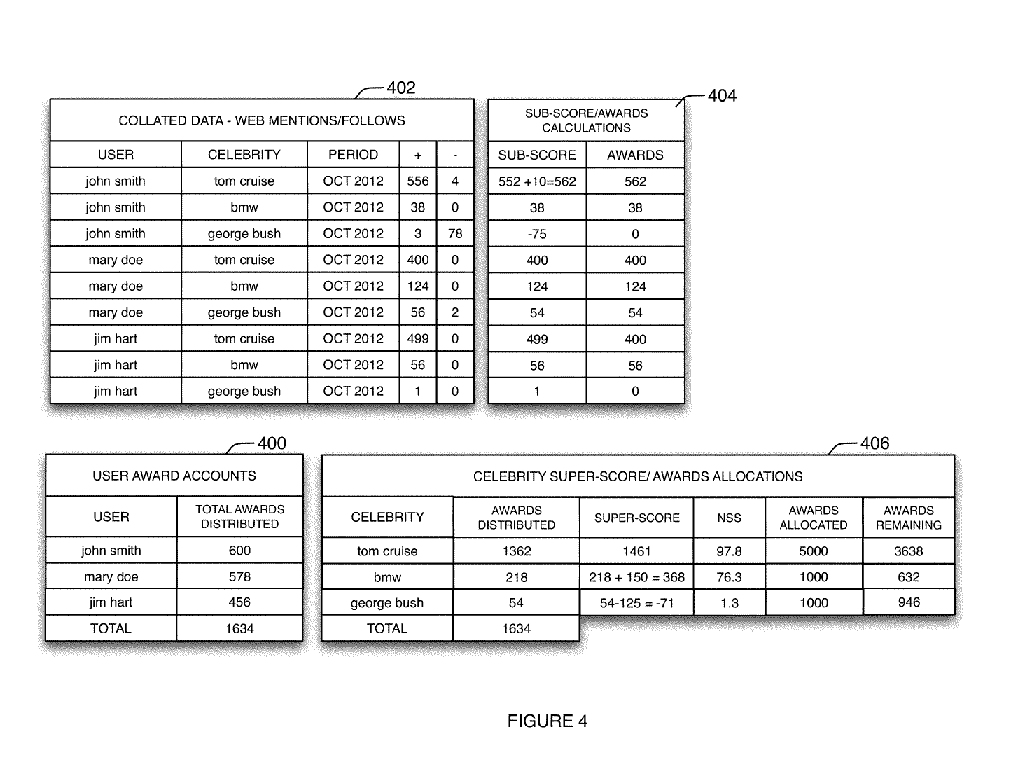

The award server computer 100 is a computer having processing circuitry, memory, data storage for storing program code as well as the awards database 104, communications circuitry for communicating over the network 108 with the other components of the system (i.e. the user computing devices, the web monitoring service 102, user data sources 124, advertisers and sponsors 106, and web sites and services 112), and other typical computer hardware and software, all of which are well known in the art. The program code executed by the processing circuitry is especially adapted to perform the functions and methods to carry out the invention as further described herein. The awards database 104 can take any format desired by the system designer in order to achieve the data storage objectives as described herein. In particular, the data tables shown in FIGS. 3 and 4 and described throughout this specification may be stored in the awards database 104 in the format shown or in any other format that will perform the functions required and carried out by this invention, as well known in the art of database architecture.

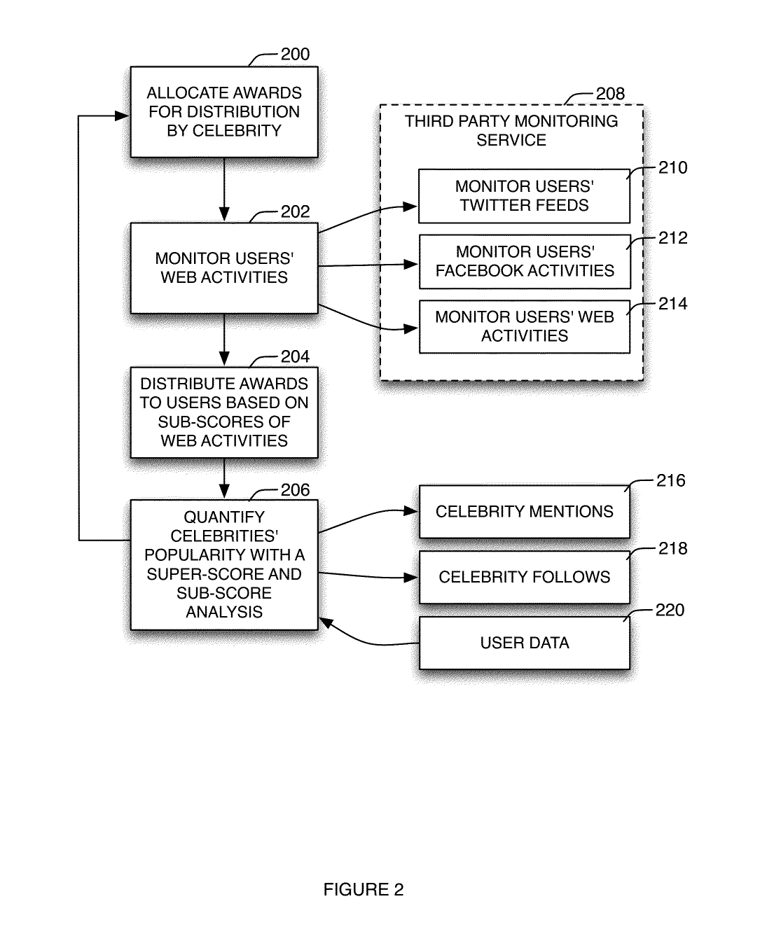

FIG. 2 illustrates the basic method implemented in the present invention for providing a celebrity awards program. First, as shown in step 200, a set of celebrity awards associated with a celebrity is allocated and stored in the database 104 of the award server computer 100. For example, Tom Cruise, a celebrity actor, may have 5,000 awards (similar to reward points) allocated to him and stored in his account at the database 104. This is shown in table 406 in FIG. 4. In one example, the celebrity may simply purchase the points from the service at one cent per point, although the price may be set in any manner agreed between the parties. As such, the purchase of 5,000 awards would cost the celebrity $50. Other scenarios exist wherein a sponsor may pay for the points and allocate them to a celebrity. For example, the movie studio that is promoting a new film starring Tom Cruise may decide to purchase 5,000 awards from the service and allocate them for marketing purposes to Tom Cruise. Likewise, the studio could purchase and allocate various sets of celebrity awards, each set being allocated to a different celebrity including each actor in the film, the director of the film, and even the movie title itself.

FIG. 4 illustrates a simple example of a celebrity award allocation table 406 from the database 104, showing that the actor Tom Cruise has 5,000 awards allocated to him, the brand BMW has 1,000 awards allocated to it, and the former president George Bush has 1,000 awards allocated to him. Of course, it is contemplated that thousands if not millions of celebrities will engage with this invention and have awards allocated, all of which would be stored in a similar set of records as shown in table 406 of FIG. 4. It is also contemplated that the number of awards allocated to a celebrity will likely be much more than 5,000 as the scale and usage of the system expands.

In step 202, various web activities of a user interacting over the web using a user computing device such as a laptop computer, desktop computer, smartphone tablet etc. are monitored. As explained above, web activities may be broadly defined and encompass any data transferred and/or stored over the Internet or other communications networks. As such, web activities could include the user mentioning the celebrity in an internet short messaging service message (such as on TWITTER), in a social networking post (such as on FACEBOOK or LINKEDIN), in a photograph post (such as on INSTAGRAM or FLICKR), in a a text message, in a blog post, in a web page, and/or in an email message, and the like. For example, if a user John Smith sends a short message (“tweet”) via the TWITTER service that mentions Tom Cruise (e.g. “Tom Cruise was great in the movie Top Gun!”), this mention will be detected and logged in table 300 (“Raw Data—Web Mentions”) of FIG. 3. Similarly, web activities could include the user following the celebrity in an internet short messaging service message (such as TWITTER), in a social networking post (such as FACEBOOK), in a photograph post (such as INSTAGRAM), etc. For example, if a user Jane Doe follows (or “likes”) the actor Dustin Hoffman on the TWITTER service, this follow will be detected and logged in table 302 (“Raw Data—Web Follows”) of FIG. 3.

The monitoring of web activities in step 202 may be undertaken by a third party web monitoring service 102 at step 208. As shown, for example, this service may be engaged to monitor users' TWITTER feeds at step 210, to monitor users' FACEBOOK activities at step 212, and to monitor users' other web activities in general at step 214. It may be required for users to agree to have their communications monitored by this service, which may be done in an end-user license agreement between the users and the relevant service. For example, when a user registers at TWITTER, he may be asked if he wants to participate in this awards program, and then give consent to have his tweets monitored. Since users will ultimately obtain awards as a result of the data being monitored for a celebrity that is mentioned, it is anticipated that most users will willingly allow their messages and the like to be monitored. In the alternative, the award server computer may have internal mechanisms for providing the web activity monitoring rather than using an outside service. In addition and/or the alternative to using a dedicated third party monitoring service, user's data feeds may be obtained directly from the service (e.g. Directly from TWITTER) by the awards server computer 100.

Various technologies are known in the art that enable the collection of data implemented in this invention from network messages and data transfers. For example, see U.S. Pat. No. 8,271,429 (SYSTEM AND METHOD FOR COLLECTING AND PROCESSING DATA), and U.S. Patent Application No. 20100042501 (METHOD AND APPARATUS FOR CONTROLLING CONTENT WITHIN A NETWORK). Also, standard web search engine and crawling techniques may be used to provide the data implemented in this system.

The form of the data that is sent from the web monitoring service to the award server computer 100 is not critical, as long as the contents of the data include the information required to carry out this process as described herein (e.g. at least the name of the celebrity, and preferably the source of the mention or follow, name of the user, date of the mention, etc.) Optionally, the raw data as set forth in tables 300 and 302 may be logged by the web monitoring service and provided to the awards server computer in tabulated or collated format if desired.

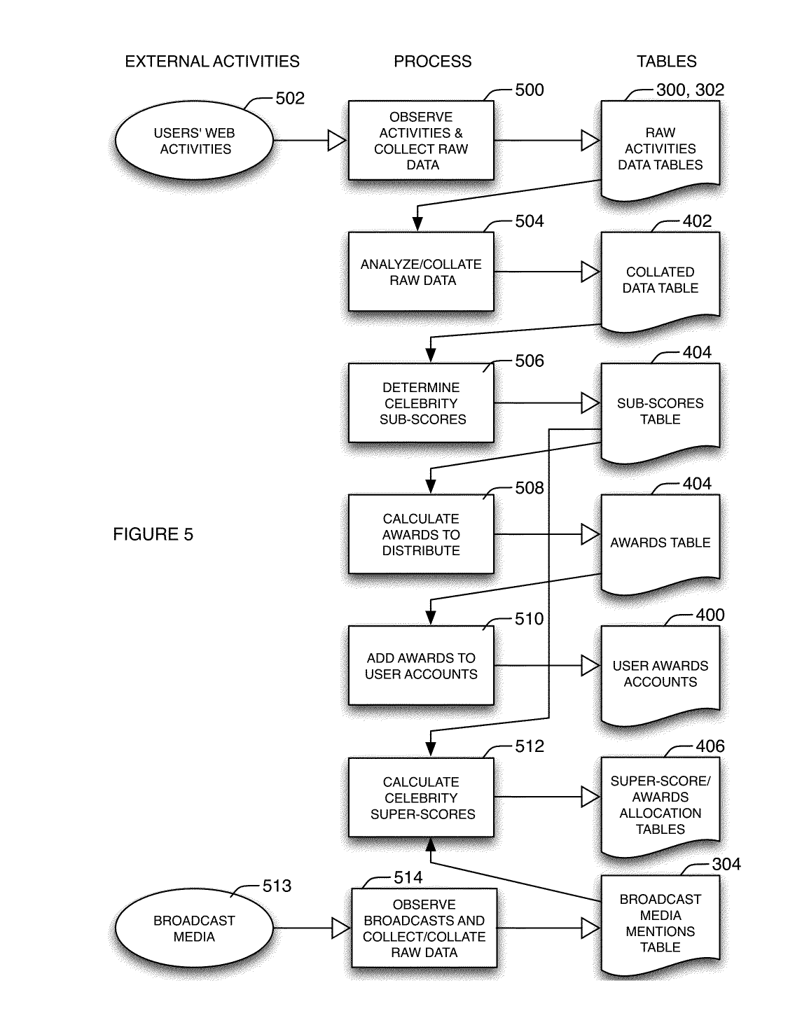

At step 204 of FIG. 2, celebrity awards are distributed to the users based on the web activities that have been monitored. The determination of the specific awards to be distributed to a particular user from a particular celebrity's allocation is based on the determination of a celebrity sub-score which is based on a correlation between the monitored web activities of the user and the celebrity. At step 206, a super-score is determined for the celebrity as a function of collating the celebrity sub-scores for all the users with respect to that celebrity. This super-score is effectively a function of both the mentions of the celebrities by the users in the system (step 216) as well as the follows of the celebrity by the users in the system (step 218). These processes are described in further detail below with respect to the flowchart of FIG. 5.

Further detail is now provided with respect to the detailed flowchart of FIG. 5 and the database tables shown in FIGS. 3 and 4. At step 500 in FIG. 5, the users' web activities 502 are observed as described above, and the raw data from observing those activities are collected from the web monitoring service 102 and logged by the award server computer in raw activities tables 300 and 302. All the tables described herein may be stored in the awards database 104. Table 300 provides for the recording of raw data that is collected with respect to the mentioning of a celebrity by a user in some manner over the web, while table 302 provides for the recording of raw data that is collected with respect to the following of a celebrity by a user in some manner over the web. In table 300, information collected includes the name of the user that has mentioned the celebrity (which may be a natural person or legal entity), the name of the celebrity mentioned (which also may be a natural person or legal entity), the type of mention (e.g. blog post, short message, social network, email message, photo post, news article, etc.), the source of the mention (i.e. the web site where the mention occurs, if any), the date the mention was logged, and a +/− flag to indicate if the celebrity has been mentioned in a positive manner or a negative manner by user. Logging this flag would require more intelligence with respect to analyzing the substance of the article, message, post, etc. that mentions the celebrity, and may be optional if desired. Thus, as shown in FIG. 3, table 300 has examples of other types of mentions that have been logged, such as user John Smith mentioning celebrity baseball player Derek Jeter in a blog post at the web site www.moviereview.com on Oct. 15, 2012. It was detected that the mention was in a positive manner rather than a negative manner, so the +/− flag is set accordingly.

Similarly, in table 302, information collected includes the name of the user that has followed the celebrity, the name of the celebrity followed, the type of follow, the source of the follow, and the date the follow was logged. For example, if a user Jane Doe follows the actor Dustin Hoffman on the TWITTER service, this follow will be detected and logged in table 302.

Next, at step 504, the raw data from tables 300 and 302 is analyzed and collated into collated data table 402 as shown in FIG. 4. FIG. 402 illustrates the total number of times that a particular user has mentioned a particular celebrity in a positive manner, as well as the total number of times that a particular user has mentioned a particular celebrity in a negative manner. For example, it has been determined from analyzing table 300 that user John Smith has mentioned the celebrity Tom Cruise in a positive manner 556 times in the month of October 2012, and has also mentioned Tom Cruise in a negative manner 4 times in October 2012. Similarly, user John Smith has mentioned the brand BMW in a positive manner 38 times in the month of October 2012, but has not mentioned BMW in a negative manner in October 2012, etc.

The celebrity sub-score may then be determined at step 506 as a function of the user mentioning the celebrity based on the collated data in table 402. In one embodiment, the sub-score may simply be the number of times the user has mentioned that celebrity in a positive manner, less the number of times the user has mentioned that celebrity in a negative manner. As such, the celebrity sub-score of George Bush for user Mary Doe would be 54, the celebrity sub-score of BMW for user John Smith would be 38, the celebrity sub-score of George Bush for user John Smith would be −75, etc. This is shown in the table 404 of FIG. 4.

As a result of the recording the raw web mentions data in table 300 and collating the data into table 402, each celebrity sub-score with respect to a particular user may be determined at step 506 as a function of the user mentioning the celebrity in an internet short messaging service message (such as TWITTER), in a social networking post (such as FACEBOOK), in a photograph post (such as INSTAGRAM), in a text message, in a blog post, in a web page, and/or in an email message, and the like. In the example given above, the celebrity sub-score is calculated as a function of the total number of times the user mentions the celebrity in a given month, but this may be changed the total in a day, a week, a year, and/or any period desired. This data may be extrapolated so that the frequency of mentions is logged, for example the number of times Tom Cruise is mentioned by user John Smith each day over the period of a month, and the sub-score may reflect this frequency in addition to or in the alternative to the total number of mentions as in the example above.

The celebrity sub-score may then also determined at step 506 as a function of the user following the celebrity as well as the mentioning of a celebrity as described above. In a simple embodiment, the act of a user following a celebrity is a one time occurrence and may be used to modify the sub-score, such as by adding a fixed number to the sub score (e.g. by adding 10 points to the sub-score), or increasing it by certain percentage (e.g. by adding 5% to the sub-score). In the alternative, the length of time that a user has followed a celebrity may affect the sub-score (e.g. by adding 10 points to the sub-score for every month user the continues to follow the celebrity, etc.). As can be seen in table 404, the Tom Cruise sub-score for user John Smith is 562, which is equal to the number of positive mentions (556) minus the number of negative mentions (4) plus 10 for following Tom Cruise on TWITTER. Other ways of modifying the sub-score may be implemented within the spirit and scope of this invention.

Thus, in those cases wherein the celebrity sub-score is determined as a function of the user following the celebrity, this may be by following the celebrity on an internet short messaging service message (TWITTER), on a social networking service (FACEBOOK), on a photograph posting service (INSTAGRAM), and the like.

Additionally, the celebrity sub-score may be determined as a function of another member of a social network to which the user belongs mentioning and/or following the celebrity. As an example, if user John Smith follows celebrity Tom Cruise on TWITTER, this will be reflected in the Tom Cruise sub-score for user John Smith. In addition, if Mary Jones, who is not a user in the celebrity award system but who is a member of John Smith's social network (e.g. FACEBOOK), also follows Tom Cruise, them John Smith will get credit for Mary Jones's follow of Tom Cruise in the Tom Cruise sub-score for John Smith. This encourages users of the system to get their friends to follow celebrities as they do in order to obtain additional celebrity awards that are based on their sub-score with that celebrity.

In step 508, the awards to be distributed to each user, based on the celebrity sub-scores determined in step 506, are calculated and logged in table 404. Simple rules and algorithms may be established to accomplish this task. Generally speaking, a user may be provided with one award from a particular celebrity for each point in the sub-score he or she has earned for that celebrity. For example, as shown in table 404, user John Smith has a Tom Cruise sub-score of 562, and is thus provided with 562 awards from Tom Cruise's allocation of awards. John Smith also has a BMW sub-score of 38, and is thus provided with 38 awards from BMW's allocation of awards. Similarly, user Mary Doe has a George Bush sub-score of 54, and is thus provided with 54 awards from George Bush's allocation of awards. A rule may be established that provides that in the case of a negative sub-score, zero awards would be distributed. Thus, since user John Smith has a sub-score of −75 for George Bush, he would receive zero awards from George Bush. Another rule may be established that provides a maximum number of awards in a given time period from a particular celebrity, such as distributing the maximum of 400 awards to Jim Hart from Tom Cruise, even though the sub score in that case is 499. Other rules are of course contemplated by this invention. Each celebrity may implement his/her/its own rules for award distribution, or the system may have default rules that are put into place.

At step 510, the celebrity awards calculated in step 508 are logged in table 404. This provides each user with the number of awards he or she has earned from each celebrity. Since redemption of the awards may be tied into the particular celebrity as described below, it is important to track how many wards each user has from each celebrity. For example, John Smith may be able to redeem his 563 Tom Cruise awards for a poster of Tom Cruise from his marketing company, but he may not be able to add in the 38 BMW points to get something of greater value. An exception to this rule is a cluster celebrity redemption process that will also be explained below that enables a user to pool rewards from celebrities that form a predefined cluster.

Notwithstanding, in some embodiments it may be useful to track the total number of awards distributed by the various celebrities by logging the totals for each user in table 400. Thus, user John Smith has amassed 562 awards from Tom Cruise, 38 awards from BMW and zero awards from George Bush, for a total of 600 awards as shown in table 400. Similar calculations are performed for each user as shown in table 400.

As shown in step 512, a celebrity super-score may be determined as a function of collating the sub-scores of all of the users and then stored in table 406. The celebrity super-score may be simply a mathematical tally of all of the sub-scores for that celebrity from each user in the system. For example, Tom Cruise has a super-score of 1362, which equals the total of his sub-scores of 562 from John Smith, 400 from Mary Doe, and 499 from Jim Hart. (Note that the number of awards distributed is only 1362, since user Jim Hart was capped at 400 awards even though his super-score was 499).

Optionally, the celebrity super-score may be determined as an additional function of mentions of the celebrity on broadcast media 513, which may be television programming, radio programming, and the like. At step 514, the broadcast media is observed, and the broadcast raw data is collected and collated in table 304 of FIG. 3 in a manner similar to the web mentions and follows described above. Table 304 may store records indicating the name of the celebrity, the type of broadcast media, the source of the media, the date of the mention of the celebrity, and a +/−flag to indicate if the celebrity has been mentioned in a positive manner or a negative manner in the broadcast. Since this embodiment of the invention monitors broadcast media, no logging with respect to a particular user is undertaken. (If desired, broadcast media from individual users may be logged in table 300 so the user identifier may be recorded). So, for example as shown in table 304, Tom Cruise was mentioned on a television show on the CBS network on Oct. 13, 2012 on a positive manner. If desired, the name of the show may also be recorded, as well as other metadata, in table 304.

Broadcast media mentions may be provided by a third party broadcast monitoring service 118, which would monitor various television and radio broadcasts, interpret the broadcasts, and provide the raw data to the award server computer as shown in table 304 of FIG. 3.

In this embodiment, the calculation of a celebrity super-score at step 512 will also incorporate the broadcast media mentions of the celebrity as logged in table 304. Thus, for example as shown in table 406, BMW has a total user mention/follow sub-score of 218 (38 from John Smith, 124 from Mary Doe, and 56 from Jim Hart). Added to this will be a broadcast media score of 150 (the number of times Tom Cruise has been mentioned in broadcast media), for a resulting super-score of 368 as shown in table 406. Optionally, the celebrity super-score may be determined as a function of the content of the mentions of the celebrity on the broadcast media, the quantity of the mentions of the celebrity on the broadcast media, the recency of the mentions of the celebrity on the broadcast media, the velocity of the mentions of the celebrity on the broadcast media, and/or the rapidity of the mentions of the celebrity on the broadcast media.

A normalized super-score (shown in table 406 as “NSS”) may be derived for example by determining a theoretical ideal super-score based on a statistical analysis of all super-scores, and then determining the percentage of a particular celebrity's super-score with respect to that ideal, or by using any normalization procedure as may be desired. For example, Tom Cruise has attained a normalized super-score of 97.8, which illustrates that he has a near-perfect popularity as measured by this system.

A sponsoring entity may provide a sponsorship to a celebrity based on the super-score of the celebrity. In addition to providing awards that may be ultimately redeemed by a user for something of value as described below, the methodology and system of the present invention provides a mechanism for sponsors, advertisers and the like to assess the popularity and marketability of a celebrity in a manner heretofore unavailable. As described above, by analyzing the mentions made by users of a particular celebrity, as well as the followers that a celebrity may have on various services such as TWITTER or LINKEDIN, this methodology derives a super-score for that celebrity that is indicative of is or her popularity, as well as trends regarding the celebrity's popularity. In a simple analysis, the higher the super-score of a celebrity, the more popular and marketable that celebrity is. In addition to analyzing the celebrity's super-score on an overall basis, the individual sub-scores may be analyzed on a more granular basis to give insight into the demographics of the users that mention and/or follow that celebrity. For example, the data from table 402 may be cross-collated with other information sources about each user, which may be stored internally or obtained from external user data sources 124 such as EXPERIAN. By looking at user demographic and psychographic information, and analyzing the sub-scores of the user for a particular celebrity or group of celebrities, further insight is attained. For example, an analysis of the data from table 402 and other user data sources may indicate that Tom Cruise is popular with users in a certain age group but not another age group. Or, the data analysis may indicate that BMW is popular with men but not women, or with users having incomes between $100K and $200K annually, etc. As such, sponsors and advertisers are able to tailor their campaigns based on this data analysis for a more efficient user of resources.

As shown in FIG. 1, the advertisers and sponsors 106 are in communication with the award server computer 100 in order to obtain the celebrity super-score and sub-score analysis information so they may if desired base their marketing campaigns on this data. Consideration may be paid in the form of service fees to the award distribution, exchange and redemption service in exchange for this valuable marketing data. The funds that are collected by the service in exchange for this marketing data may then be used to fund the awards that are distributed to the users, since as will be described below those awards may be redeemed by the users for items of value. Thus, the program may perpetuate as a function of the popularity of the celebrities and the ability of the sponsors to pay into the system in exchange for the valuable marketing and popularity information.

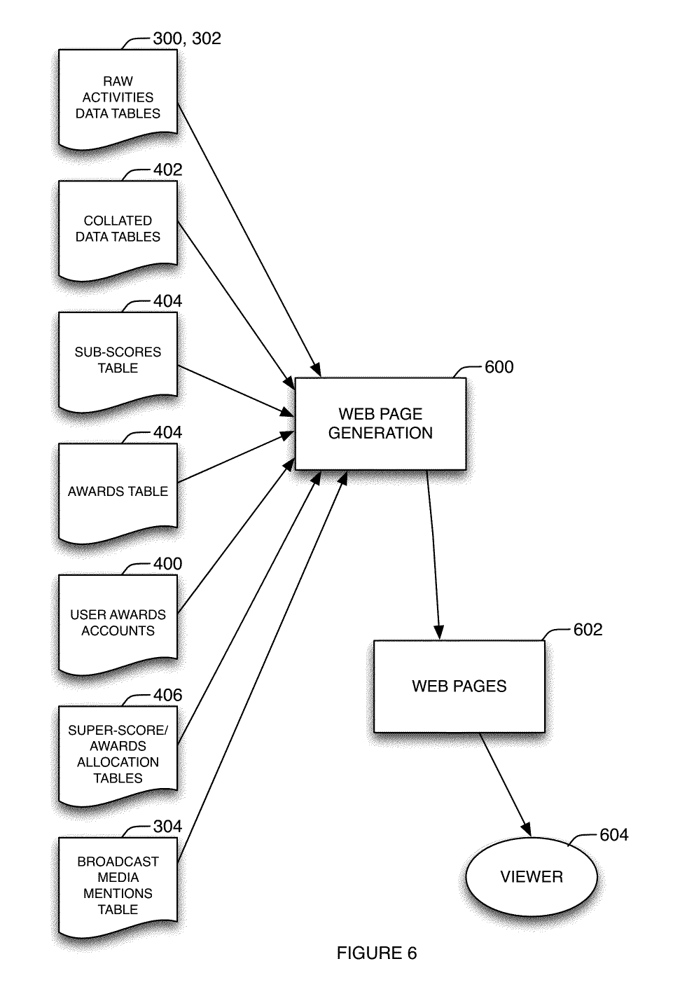

Web pages 602 may be generated by web page generation module 600 that is executed by the award server computer 100 for serving to a viewer 604 as shown in FIG. 6. A viewer 604 may be a celebrity, an agent of the celebrity, a user, a sponsor, an advertiser, or any other interested entity. Here, all of the data from the tables in FIGS. 3 and 4 as described above may be used by the web page generation module 600 using filters that may be selected by the viewer 604 for presentation to and analysis by the viewer 604 using any computing device such as a laptop computer, desktop computer, tablet, smartphone, interactive television, etc. The web pages 602 may for example provide a comparison of a celebrity super-score with other celebrity super-scores. This provides the viewer with a means for understanding the popularity of the celebrity as measured by the system of the present invention, individually and/or in comparison with other celebrities, in order to gauge the value or worth of that celebrity to that sponsor.

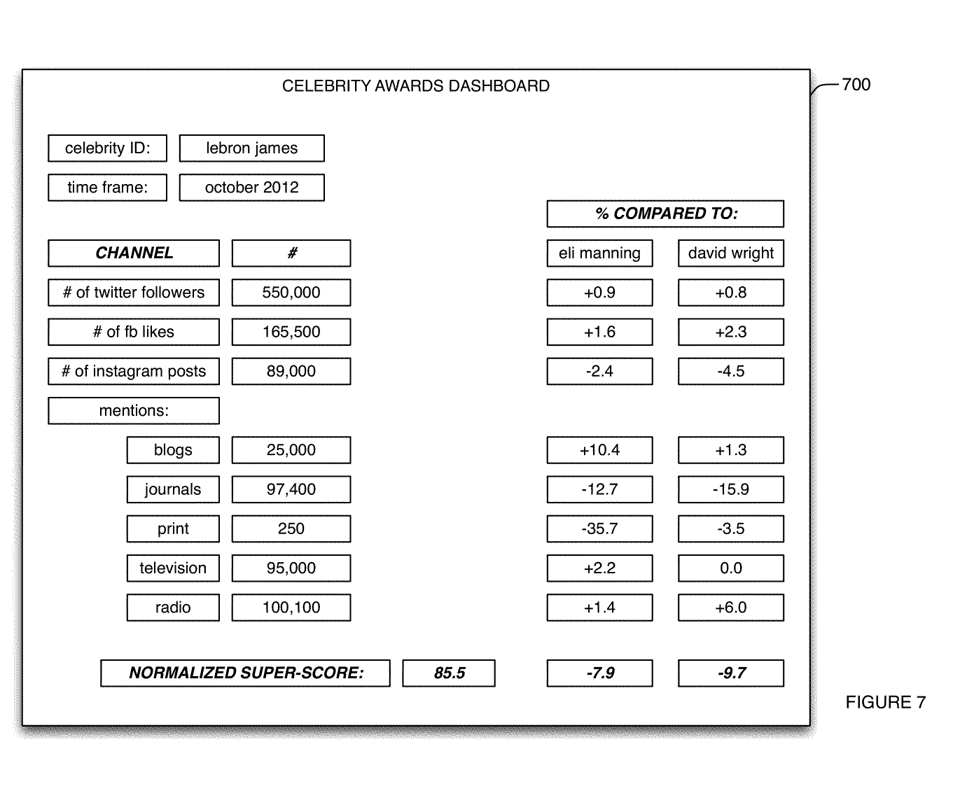

FIG. 7 shows an exemplary web page 700 that may be generated by the system, which is entitled CELEBRITY AWARDS DASHBOARD. This particular web page provides a display of various data about the celebrity athlete LeBron James in the month of October 2012. The viewer may enter a different celebrity name and/or time frame, if desired. Password login credentials may be required in order to provide a secure system. The overall data provided on page 700 as shown in this example is the total number of TWITTER followers (550,000), the number of FACEBOOK “likes” (165,500), the number of INSTAGRAM posts of LeBron James (89,000), and the number of mentions of LeBron James (25,000 in blogs; 97,400 in journals; 250 in print; 95,000 in TV, and 100,100 in radio). The normalized super-score (85.5) is also displayed on the web page 700. A comparison section is provided so the viewer can view how that celebrity measures against a different celebrity. Here, the viewer is looking at a comparison of the displayed data with respect to Eli Manning and David Wright. Virtually any of the raw and/or collated data may be provided to the viewer via this or similar web pages, which will enable the viewer to gain insight into the popularity of the celebrity that is heretofore unavailable.

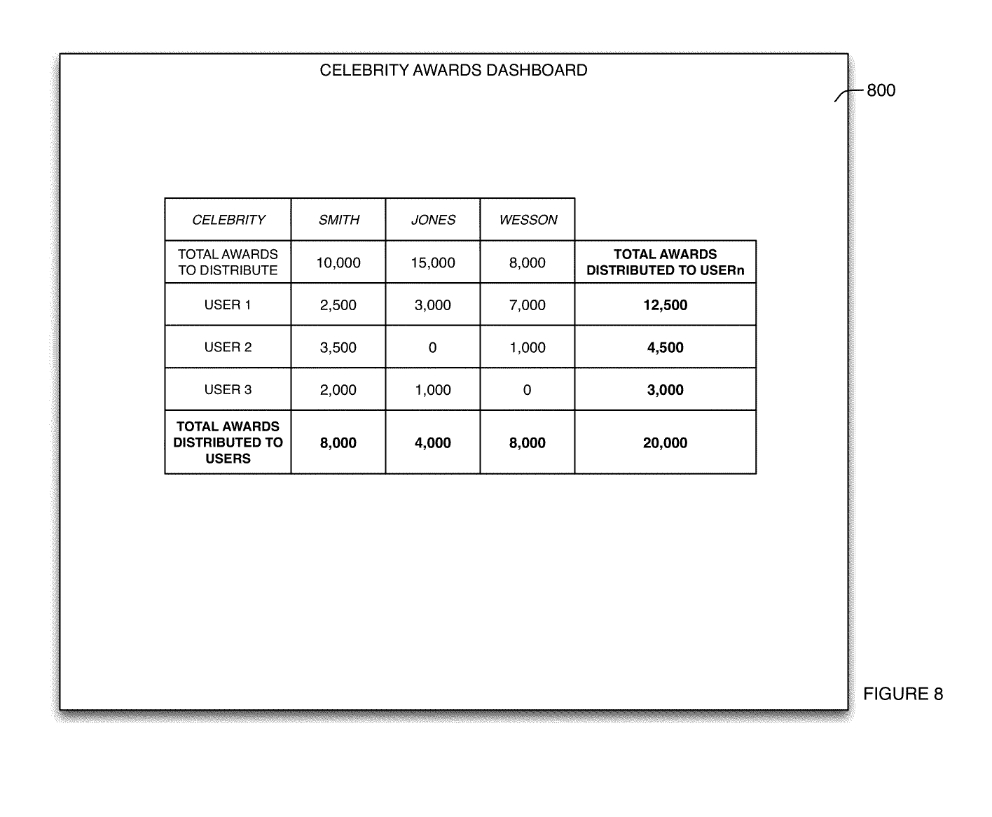

FIG. 8 illustrates an alternative web page 800 that shows the viewer various aspects of the awards that have been distributed for each celebrity and to each user. This is useful if there is a group of related celebrities, such as artists that produce records under the same record label, whereby the label producer or sponsor can look at data regarding those celebrities in a convenient and robust manner.

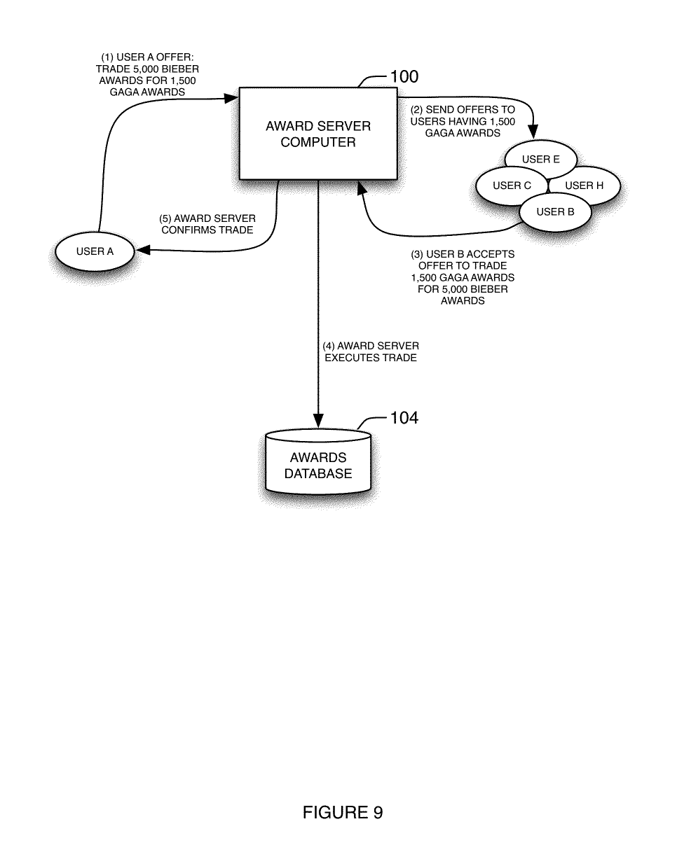

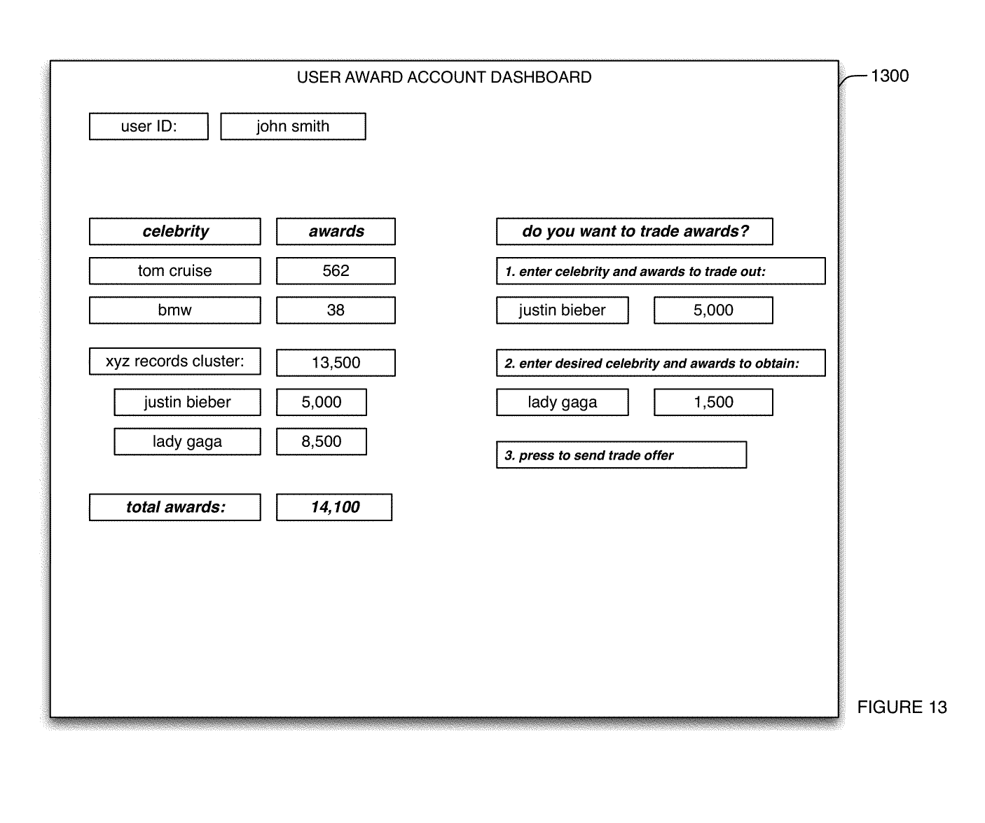

In an additional embodiment, an award exchange, purchase and bidding system is provided. This will enable users of the system to purchase awards, trade awards, and redeem awards as will now be described. FIG. 9 is an illustration of a flowchart that provides for a method of arranging and executing a trade of awards between different users. FIG. 13 illustrates a web page 1300 that a user will receive from the award server computer that shows the various awards a user has earned from each celebrity. Here, user A (John Smith) has earned 562 awards from Tom Cruise, 38 awards from BMW, 5,000 awards from Justin Bieber, and 8,500 awards from Lady Gaga. In addition, a celebrity cluster has been defined as XYZ Records, since both Justin Bieber and Lady Gaga are artists on that label. As a result, the user has 13,500 clustered XYZ Records awards.

In this example, user John Smith views his award accounts as shown in FIG. 13, and decides he would like to increase his Lady Gaga awards quickly to 10,000 since Lady Gaga has offered a redemption of 10,000 awards in exchange for a VIP pass to her next concert. John Smith is not interested any more in Justin Bieber, so he would like to trade his 5,000 Justin Bieber awards for the desired 1,500 Lady Gaga awards. John Smith can select on web page 1300 Justin Bieber as the desired celebrity to trade out and enter 5,000 awards, and then enter into web page 1300 Lady Gaga as the desired celebrity and 1,500 as the desired number of awards to obtain for Lady Gaga. John Smith then selects the send offer button.

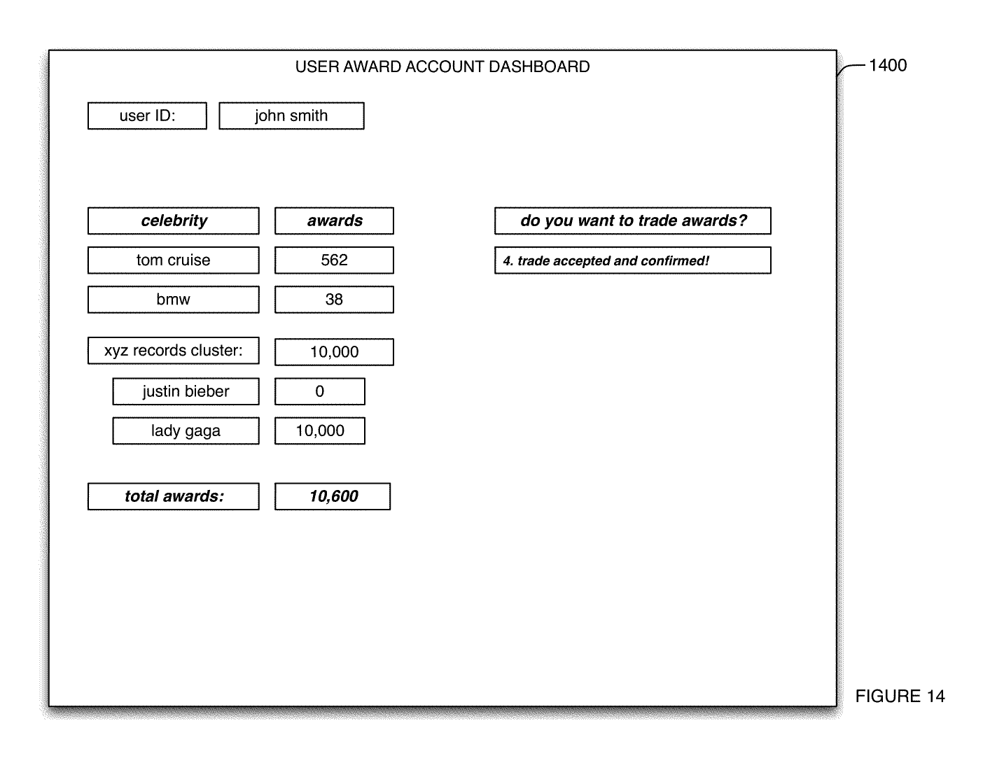

Thus, John Smith as a first user A sends at step 1 of FIG. 9 to the award server computer an offer to trade a first group of celebrity awards (5,000) that are associated with a first celebrity (Justin Bieber) from the first user's account. John Smith as user A would like to obtain in exchange for the 5,000 Bieber awards a second group of celebrity awards (1,500) associated with a second celebrity (Lady Gaga). That is, John Smith as user A would like to obtain 1,500 Lady Gaga awards for his 5,000 Justin Bieber awards. The award server receives this offer from user A, and then searches through the awards database 104 (e.g. table 404) to determine which if any user(s) may have 1,500 Lady Gaga awards to trade. The award server computer then sends at step 2 the trade offer to any user who in fact has the desired awards, which in the example of FIG. 9 are users B, C, E, and H. If one of those users then desires to make the requested trade, then that user (user B here) sends his acceptance of the offer at step 3 to the award server computer. The award server computer may then at step 4 execute the trade between the first user and the second user by subtracting from the first user's account the first group of celebrity awards (i.e. 5,000 Bieber awards) and adding them to the second user's account (user B's account), and also subtracting from the second user's account the second group of celebrity awards (i.e. 1,500 Gaga awards) and adding them to the first user's account. In the event that multiple users send acceptances of user A's offer to exchange, then the award server computer can opt to use the first acceptance, or it can send all the acceptances back to the user A and let user A select who to trade with, or allow user A to restructure his offer to a higher bid (e.g. obtain more Gaga awards, or other celebrity awards, etc.). Confirmation of the trade is made at step 5. As can be seen on web page 1400 in FIG. 14, John Smith now has 10,000 Lady Gaga awards and zero Justin Bieber awards.

John Smith as user A may alternatively offer to trade his 5,000 Bieber awards without specifying which awards he would like in return, thus prompting bids from various users who may be interested in obtaining those Bieber awards. User A could then execute a bidding process with the various responding users through the award server computer 100 acting as an intermediary.

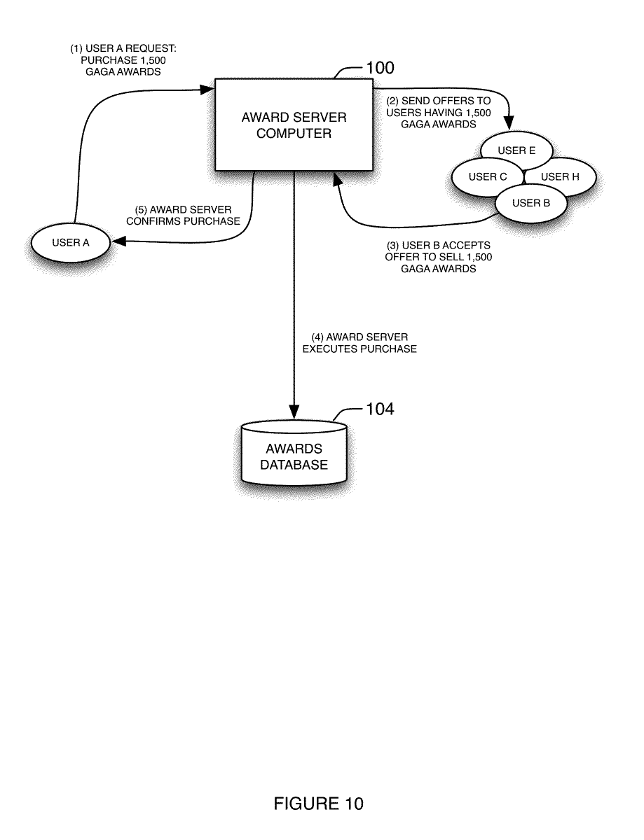

The award server computer may also execute an award purchase transaction as follows. As shown in FIG. 10, the award server computer may at step 1 receive from a first user (user A) a request to purchase a first group of celebrity awards associated with a first celebrity (e.g. 1,500 Gaga awards). The award server computer 100 then searches through the awards database 104 (e.g. table 404) to determine which if any user may have 1,500 Lady Gaga awards to sell. The award server computer then sends at step 2 the purchase offer to any user who in fact has the desired awards, which in the example of FIG. 10 are users B, C, E, and H. If one of those users then desires to make the requested sale, then that user (user B here) sends his acceptance of the offer at step 3 to the award server computer. The award server computer may then at step 4 execute the purchase by the first user by subtracting from the second user's account the second group of celebrity awards (i.e. 1,500 Gaga awards) and adding them to the first user's account. In the event that multiple users send acceptances of user A's offer to purchase, then the award server computer can opt to use the first acceptance, or it can send all the acceptances back to the user A and let user A select who to deal with, or allow user A to restructure his offer. Confirmation of the purchase is made at step 5.

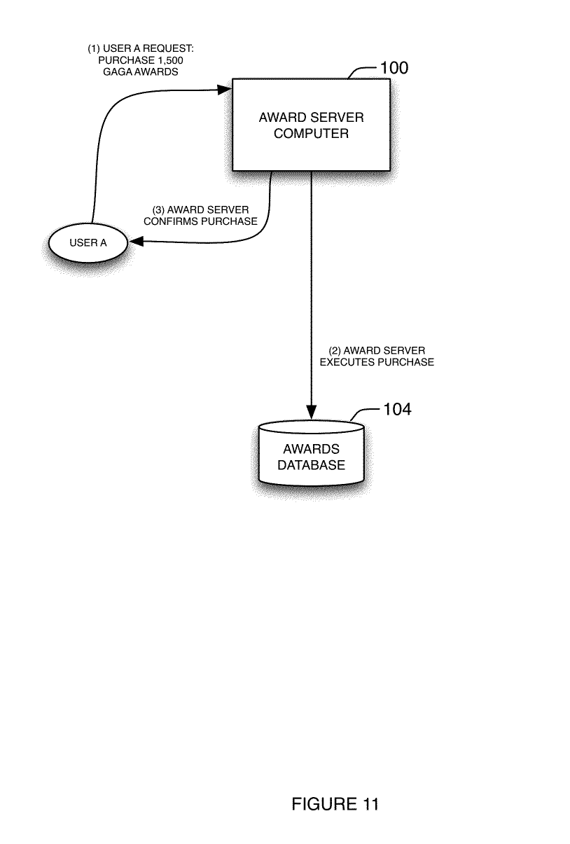

Similarly, with reference to FIG. 11, the purchase may be made directly from the award server computer from the general allocation of celebrity awards stored in the award database 104. So, here at step 1, the award server computer receives from a first user (user A) a request to purchase a first group of celebrity awards associated with a first celebrity (e.g. 1,500 Gaga awards). The award server computer at step 2 executes the purchase by subtracting from a set of celebrity awards associated with the first celebrity allocated in the award server computer the first group of celebrity awards (1,500 Gaga awards) and adding them to user A's account. Confirmation of the purchase is made at step 3.

In either of the purchase scenarios described above, consideration would be paid to the seller by user A as may be agreed to between the parties.

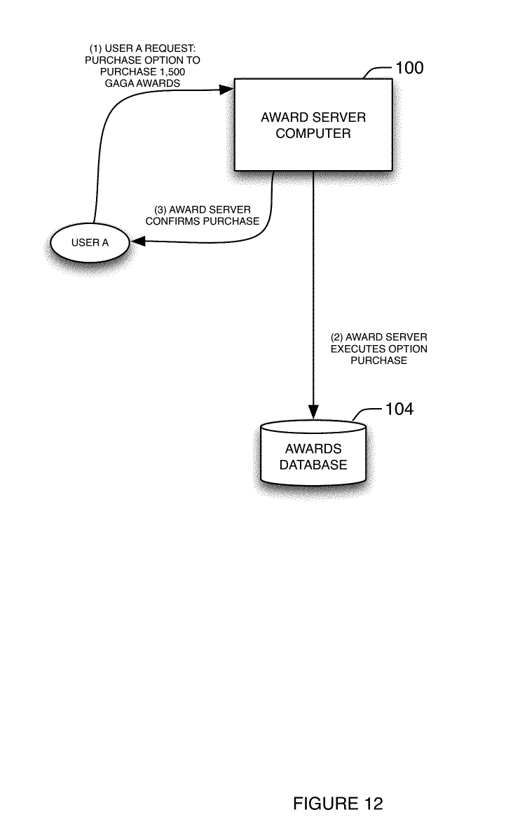

As shown in FIG. 12, the award server computer may receive at step 1 from a first user (user A) a request to purchase an option to purchase in the future a first group of celebrity awards associated with a first celebrity (e.g. 1,500 Gaga awards). Then, the award server computer may execute the option purchase at step 2 by establishing an option purchase price and conveying to user A the option to purchase in the future the 1,500 Gaga awards in exchange for consideration equivalent to the option purchase price. Confirmation of the purchase is made at step 3.

The users who have earned celebrity rewards using this system may at some time execute an award redemption process in order to obtain items of value in exchange for their earned awards. A catalog of items available for redemption may be provided by the awards server computer, typically in web page format. The redemption web page would list various items available and indicate the number of awards that may be required to purchase the item. An item may be associated with a celebrity such that only awards earned from that celebrity may be used to obtain that item. For example, the Rolling Stones may offer a VIP concert package with backstage access in exchange for 50,000 Rolling Stones awards.

In this award redemption phase, the award server computer receives from a first user (e.g. user A), a request to redeem a first group of celebrity awards associated with a first celebrity (e.g. 5,000 Bieber awards) from his user account in exchange for a desired item. The award server computer then subtracts from user A's account the required celebrity awards in exchange for the item associated with the celebrity. Alternatively, the award server computer may form a celebrity cluster that includes multiple celebrities related in some manner, such as various recording artists on the same label. The award server computer would then receive from user A a request to redeem from the user A account a first group of celebrity awards (e.g. 5,000 Bieber awards) and a second group of celebrity awards (e.g. 1,500 Gaga awards) in exchange for an item associated with the celebrity cluster (e.g. tickets to a concert featuring Justin Bieber and Lady Gaga, assuming they are both on the same label and in the same cluster).

Various embodiments described herein or portions thereof can be combined without departing from the present invention.

Furthermore, the above described embodiments of the present invention are presented for purposes of illustration and not of limitation, and the present invention is limited only by the claims which follow.

What is claimed is:

1. A method of providing a multi-user, multi-entity award distribution, exchange and redemption program comprising:
a) allocating in an award server computer a plurality of sets of entity awards, each of the plurality of sets of entity awards associated with one of a plurality of entities;
b) monitoring web activities of a plurality of users interacting over a computer network;
c) for each of the plurality of entities,
for each of the plurality of users,
determining an entity sub-score based on a correlation between the entity and the monitored web activities of the user, and
distributing, based on the entity sub-score for the entity with the user, a portion of the set of entity awards associated with the entity to a user account associated with the user.

2. The method of claim 1 wherein the entity sub-score is a function of the user mentioning the entity.

3. The method of claim 1 wherein the entity sub-score is a function of the user following the entity.

4. The method of claim 3 wherein the entity sub-score is a function of a member of a social network to which the user belongs mentions the entity.

5. The method of claim 3 wherein the entity sub-score is a function of a member of a social network to which the user belongs follows the entity.

6. The method of claim 1 further comprising:
for each of the plurality of entities, determining an entity super-score as a function of collating the entity sub-scores for the entity.

7. The method of claim 6 wherein the entity super-score is additionally a function of mentions of the entity on broadcast media.

8. The method of claim 6 further comprising the step of a sponsoring entity providing sponsorship to one of the plurality of entities based on the super-score of the entity.

9. The method of claim 8 wherein the set of entity awards associated with the entity is allocated based on the sponsorship of the entity.

10. The method of claim 1 further comprising the award server computer receiving from a first user, selected from the plurality of users, an offer to trade a first group of entity awards associated with a first entity, selected from the plurality of entities, from the user account associated with the first user in exchange for a second group of entity awards associated with a second entity, selected from the plurality of entities.

11. The method of claim 10 further comprising the award server computer receiving from a second user, selected from the plurality of users, an acceptance of the offer to trade with the first user, by offering to the first user the second group of entity awards associated with the second entity from the user account associated with the second user.

12. The method of claim 11 further comprising the award server computer executing the trade between the first user and the second user by:
subtracting from the user account associated with the first user the first group of entity awards associated with the first entity and adding to the user account associated with the second user the first group of entity awards associated with the first entity; and
subtracting from the user account associated with the second user the second group of entity awards associated with the second entity and adding to the user account associated with the first user the second group of entity awards associated with the second entity.

13. The method of claim 1 further comprising:
the award server computer receiving from a first user, selected from the plurality of users, a request to purchase a first group of entity awards associated with a first entity, selected from the plurality of entities;
the award server computer receiving from a second user, selected from the plurality of users, an agreement to sell to the first user the first group of entity awards associated with the first entity; and
the award server computer executing the purchase by
subtracting from a user account associated with the second user the first group of entity awards associated with the first entity and adding to a user account associated with the first user the first group of entity awards associated with the first entity.

14. The method of claim 1 further comprising:
the award server computer receiving from a first user, selected from the plurality of users, a request to purchase a first group of entity awards associated with a first entity, selected from the plurality of entities;
the award server computer executing the purchase by
subtracting from a set of entity awards associated with the first entity allocated in the award server computer the first group of entity awards associated with the first entity and adding to a user account associated with the first user the first group of entity awards associated with the first entity.

15. The method of claim 1 further comprising:
the award server computer receiving from a first user, selected from the plurality of users, a request to purchase an option to purchase in the future a first group of entity awards associated with a first entity, selected from the plurality of entities;
the award server computer executing the option purchase by
establishing an option purchase price; and
conveying to the first user the option to purchase in the future the first group of entity awards associated with the first entity in exchange for consideration equivalent to the option purchase price.

16. The method of claim 1 further comprising the award server computer receiving from a first user, selected from the plurality of users, a request to redeem a first group of entity awards associated with a first entity, selected from the plurality of entities, from the user account associated with the first user by subtracting from the user account associated with the first user the first group of entity awards associated with the first entity in exchange for an item associated with the first entity.

17. The method of claim 1 further comprising the award server computer:
forming an entity cluster comprising a first entity selected from the plurality of entities and a second entity selected from the plurality of entities; and
receiving from a first user, selected from the plurality of users, a request to redeem from the user account associated with the first user a first group of entity awards associated with the first entity and a second group of entity awards associated with the second entity in exchange for an item associated with the entity cluster.

18. A award server computer for providing a multi-user, multi-entity award, exchange and redemption program comprising:
a database for storing a plurality of sets of entity awards, each of the plurality of sets of entity awards allocated to and associated with one of a plurality of entities; and
processing means programmed to:
for each of the plurality of entities,
for each of a plurality of users,
determine an entity sub-score based on a correlation between the entity and a set of monitored web activities of a user from the plurality of users interacting over a computer network, and
distribute, based on the entity sub-score for the entity with the user, a portion of the entity awards to a user account associated with the user.

19. The award server computer of claim 18 wherein the processing means is programmed to determine the entity sub-score as a function of the user mentioning the entity.

20. The award server computer of claim 19 wherein the processing means is programmed to determine the entity sub-score as a function of the user following the entity.

21. The award server computer of claim 19 wherein the processing means is programmed to determine the entity sub-score as a function of a member of a social network to which the user belongs mentions the entity.

22. The award server computer of claim 19 wherein the processing means is programmed to determine the entity sub-score as a function of a member of a social network to which the user belongs follows the entity.

23. The award server computer of claim 18 wherein the processing means is further programmed to determine, for each of the plurality of entities, an entity super-score as a function of collating the entity sub-scores for the entity.

24. The award server computer of claim 23 wherein the processing means is further programmed to determine an entity super-score as a function of mentions of the entity on broadcast media.

25. The award server computer of claim 24 wherein a sponsoring entity provides sponsorship to an entity based on the super-score of the entity.

26. The award server computer of claim 25 wherein the set of entity awards associated with an entity is allocated based on the sponsorship of the entity.

27. The award server computer of claim 18 wherein the processing means is further programmed to receive from a first user, selected from the plurality of users, an offer to trade a first group of entity awards associated with a first entity, selected from the plurality of entities, from the user account associated with the first user in exchange for a second group of entity awards associated with a second entity, selected from the plurality of entities.

28. The award server computer of claim 27 wherein the processing means is further programmed to receive from a second user, selected from the plurality of users, an acceptance of the offer to trade with the first user, by offering to the first user the second group of entity awards associated with the second entity from the user account associated with the second user.

29. The award server computer of claim 28 wherein the processing means is further programmed to execute the trade between the first user and the second user by:
subtracting from the user account associated with the first user the first group of entity awards associated with the first entity and adding to the user account associated with the second user the first group of entity awards associated with the first entity; and
subtracting from the user account associated with the second user the second group of entity awards associated with the second entity and adding to the user account associated with the first user the second group of entity awards associated with the second entity.

30. The award server computer of claim 18 wherein the processing means is further programmed to:
receive from a first user, selected from the plurality of users, a request to purchase a first group of entity awards associated with a first entity, selected from the plurality of entities;
receive from a second user, selected from the plurality of users, an agreement to sell to the first user the first group of entity awards associated with the first entity; and
execute the purchase by
subtracting from a user account associated with the second user the first group of entity awards associated with the first entity and adding to a user account associated with the first user the first group of entity awards associated with the first entity.

31. The award server computer of claim 18 wherein the processing means is further programmed to:
receive from a first user, selected from the plurality of users, a request to purchase a first group of entity awards associated with a first entity, selected from the plurality of entities; and
execute the purchase by
subtracting from a set of entity awards associated with the first entity allocated in the award server computer the first group of entity awards associated with the first entity and adding to a user account associated with the first user the first group of entity awards associated with the first entity.

32. The award server computer of claim 18 wherein the processing means is further programmed to:
receive from a first user, selected from the plurality of users, a request to purchase an option to purchase in the future a first group of entity awards associated with a first entity, selected from the plurality of entities;
execute the option purchase by
establishing an option purchase price; and
conveying to the first user the option to purchase in the future the first group of entity awards associated with the first entity in exchange for consideration equivalent to the option purchase price.

33. The award server computer of claim 18 wherein the processing means is further programmed to receive from a first user, selected from the plurality of users, a request to redeem a first group of entity awards associated with a first entity, selected from the plurality of entities, from the user account associated with the first user by subtracting from the user account associated with the first user the first group of entity awards associated with the first entity in exchange for an item associated with the first entity.

34. The award server computer of claim 18 wherein the processing means is further programmed to:
form an entity cluster comprising a first entity selected from the plurality of entities and a second entity selected from the plurality of entities; and
receive from a first user, selected from the plurality of users, a request to redeem from the user account associated with the first user a first group of entity awards associated with the first entity and a second group of entity awards associated with the second entity in exchange for an item associated with the entity cluster.
